(19) United States
(12) Patent Application Publication
(10) Pub. No.: US 2010/0080962 A1
(43) Pub. Date: Apr. 1, 2010

(54) INK COMPOSITION FOR INK JET RECORDING

(75) Inventors: Shuichi KOGANEHIRA, Matsumoto-shi (JP); Hironori Sato, Shiojiri-shi (JP)

Correspondence Address: LADAS & PARRY LLP, 26 WEST 61ST STREET, NEW YORK, NY, 10023, US

(73) Assignee: SEIKO EPSON CORPORATION

(21) Appl. No.: 12/339,461

(22) Filed: Dec. 19, 2008

(30) Foreign Application Priority Data
Dec. 21, 2007 (JP) 2007-330839
Feb. 8, 2008 (JP) 2008-029549
May 13, 2008 (JP) 2008-125944

(51) Int. Cl. C09D 11/02; B05D 5/00; B32B 3/10; C09D 183/04; C09D 133/02; C09D 175/04; C09D 127/12

(52) U.S. Cl. 428/195.1; 106/31.13; 106/31.6; 427/256; 427/288; 524/588; 524/556; 524/589; 524/544

(57) ABSTRACT

An object of the present invention is to provide an ink composition that enables high-quality images having no white stripes or roughness to be obtained even when the images are printed on printing paper, such as art paper, at low resolution, and the ink composition is an ink composition for ink jet recording containing at least a coloring material, water, an alcohol solvent, and a surfactant, wherein the alcohol solvent contains an alkanediol sparingly soluble in water, a water-soluble 1,2-alkanediol, and a water-soluble 1,3-alkanediol.

### CROSS-REFERENCES TO RELATED APPLICATIONS

The entire disclosure of Japanese Patent Application No. 2007-330839, filed on Dec. 21, 2007, No. 2008-029549, filed on Feb. 8, 2008, No. 2008-125944, filed on May 13, 2008, are expressly incorporated by reference herein.

### FIELD OF THE INVENTION

The present invention relates to an ink composition for ink jet recording that enables high-quality prints having no print spots to be obtained on several kinds of recording media, in particular, synthetic paper, printing paper, resin films, and other recording media having low water absorbency.

### BACKGROUND OF THE INVENTION

Ink jet recording is a printing method in which droplets of ink are ejected and adhere to a recording medium, such as paper, to make a print. A recent innovative advance in ink jet recording technology has allowed ink jet recording to be used even in the field of high-resolution printing, which could not have been achieved without silver halide photography or offset processes. As a result of this, ink for ink jet recording that can be used with recording media having good gloss comparable to that of photographic paper, art paper, or other media used in the fields of silver halide photography and offset processes, so-called specialized paper, and that can be used to print images as glossy as those obtained using silver halide photography has been developed. Ink for ink jet recording that can provide image quality as high as that achieved using silver halide photography even when used with plain paper has also been developed.

Meanwhile, recent wide spread use of technology for creating images from digital data has stimulated demand for digital color proofing (DTP) particularly in the field of printing, and ink jet recording has started to be used also for DTP. DTP requires reproduction of colors and stability of prints. Thus, when proofs are produced using ink jet recording, paper exclusive for ink jet recording is usually used.

In the application of color proofing, however, there is a demand for using printing paper rather than such exclusive paper in ink jet printing. If prints obtained by direct ink jet recording on printing paper can be used as the final reference proofs instead of those obtained using exclusive paper, cost related to proofing can be significantly reduced. Furthermore, synthetic paper that is formed from films obtained by mixing polyethylene resin or polyester resin with an inorganic filler and that has been commonly used in the field of printing is excellent in terms of recyclability and thus has recently been drawing attention as an eco-friendly material.

Printing paper is coated paper whose surface has a coating layer for receiving oil-based ink, but also has a feature that the coating layer is poor in terms of ink absorbency. This means that water-pigment ink commonly used in ink jet recording cannot fully penetrate into such a recording medium (printing paper), thereby causing image blurs and aggregation unevenness.

As a solution to this problem, for example, Japanese Unexamined Patent Application Publication No. 2005-194500 (Patent Document 1) discloses pigment ink that contains a polysiloxane compound as a surfactant and an alkanediol, such as 1,2-hexanediol, as a dissolution aid, thereby resulting in less blurs and providing excellent gloss when printed on specialized paper. Also, Japanese Unexamined Patent Application Publication No. 2003-213179 (Patent Document 2) proposes that the permeability of ink to a recording medium can be controlled by adding a water-soluble organic solvent such as glycerin or 1,3-butanediol thereto, and this enables production of high-quality images.

### [Patent Document 1] Japanese Unexamined Patent Application Publication No. 2005-194500

### [Patent Document 2] Japanese Unexamined Patent Application Publication No. 2003-213179

### SUMMARY OF THE INVENTION

The inventors proposed in a previous patent application (Japanese Patent Application No. 2007-241158) that high-quality images having no white stripes or roughness can be obtained by adding a surfactant, such as polysiloxane, and two alkanediols and an alkanetriol as an alcohol solvent even when the images are printed on a low-liquid-absorbency recording medium such as printing paper at low resolution.

Recently, the inventors found that the use of a certain alkanediol instead of the alkanetriol enables printing of high-quality images having no white stripes or roughness not only on printing paper but also on a recording media having no liquid absorbency, such as a resin film. The present invention is based on these findings.

Therefore, an object of the present invention is to provide an ink composition that enables high-quality images having no white stripes or roughness to be obtained even when the images are printed on low-liquid-absorbency recording media, such as printing paper and resin films, at low resolution.

Additionally, the ink composition for ink jet recording according to the present invention is an ink composition for ink jet recording containing at least a coloring material, water, an alcohol solvent, and a surfactant, wherein

the alcohol solvent contains an alkanediol sparingly soluble in water, a water-soluble 1,2-alkanediol, and a water-soluble 1,3-alkanediol.

The present invention enables high-quality images having no white stripes or roughness to be obtained even when the images are printed on low-liquid-absorbency recording media such as printing paper and resin films at low resolution.

### DETAILED DESCRIPTION OF THE PRESENT INVENTION

The ink composition for ink jet recording according to the present invention is an ink composition for ink jet recording containing at least a coloring material, water, an alcohol solvent, and a surfactant, wherein

the alcohol solvent contains an alkanediol sparingly soluble in water, a water-soluble 1,2-alkanediol, and a water-soluble 1,3-alkanediol. The explanations of the individual components are as follows.

### DEFINITION

The alkanediol mentioned in this specification may be a linear chain or a branched chain.

The term “water-soluble” means that the solubility in water (the amount of a solute relative to 100 g of water) is 10.0 g or higher, whereas the term “sparingly soluble in water” means that the solubility in water (the amount of a solute relative to 100 g of water) is less than 1.0 g.

### <Alcohol Solvent>

The alcohol solvent used in the ink composition for ink jet recording according to the present invention contains at least three organic solvents, namely an alkanediol sparingly soluble in water, a water-soluble 1,2-alkanediol, and a water-soluble 1,3-alkanediol. Containing these three alcohol solvents as essential components, the ink composition enables printing of high-quality images having no white stripes or roughness and reduced ink aggregation on printing paper, in particular, paper having relatively high ink-absorbency such as art paper, POD paper (e.g., Ricoh Business Coat Gloss 100 manufactured by Ricoh Company, Ltd.), and paper exclusive for laser printers (e.g., LPCCTA4 manufactured by Seiko Epson Corporation) even at low resolution and, furthermore, enables printing of high-quality images having no white stripes or roughness on recording media having little ink-absorbency such as resin films.

It should be noted that the term “aggregation” used in this specification means localized concentration spots in colors of similar hue formed when ink is printed on a certain area (e.g., when a single color (not the number of ink colors) is printed on an area 4 inches square) and thus does not mean that some areas of the surface of a recording medium are left uncovered with ink. The term “white stripe” refers to a phenomenon that, when ink is printed on a certain area (e.g., when a single color is printed on an area 4 inches square), no localized color-concentration spots in colors of similar hue are formed, but some areas of the surface of a recording medium are left uncovered with the ink over stripes. The term “roughness” or “burial defect” refers to a phenomenon that, when ink is printed on a certain area as described above, no localized color-concentration spots in colors in similar hue are formed, but some areas of the surface of a recording medium are left uncovered with the ink, thereby providing the surface of the recording medium with graininess.

The reason that an ink composition containing an alkanediol sparingly soluble in water, a water-soluble 1,2-alkanediol, and a water-soluble 1,3-alkanediol as essential components enables printing of high-quality images having no white stripes or roughness as described above is unclear, but it is probably as follows.

Ink aggregation that occurs when printing paper is used for recording is probably a result of the ink being repelled by the printing paper due to high surface tension of ink dots and a large contact angle between the surface of the printing paper and each ink droplet. Reduction of the surface tension of ink adhering to the surface of printing paper would prevent such ink aggregation even when white stripes or burial defects occur in recording at low resolution.

Also, these white stripes and burial defects occurring in recording at low resolution are probably caused by ink dots adhering to the surface of printing paper coming into contact with adjacent ink dots and spreading while wetting each other, thereby interactively flowing before being dried. This interactive ink flow is probably due to the fact that the time to dry is different among adjacent ink dots because of differences in the adhesion time among the ink dots and the size of droplets at the time of adhesion. To print high-quality images having no white stripes or roughness even at low resolution while preventing ink aggregation, therefore, it may be preferable that ink that adheres to printing paper have low surface tension and low fluidity.

However, when low fluidity of ink is achieved by excluding any permeable lubricant from the ink, ink dots adhering to the surface of printing paper rapidly dry and the ink is swiftly absorbed. This probably deprives the adhering ink dots of time to spread while wetting each other, thereby causing white stripes or burial defects in recording at low resolution.

The water-soluble 1,3-alkanediol used in the present invention is a substance having viscosity as glycerin; however, the water-soluble 1,3-alkanediol is also a permeable lubricant having lower surface tension than glycerin. For example, a 10% solution of 1,3-butanediol has a surface tension of 55 mN/m, and a 10% solution of 3-methyl-1,3-butanediol has a surface tension of 53 mN/m.

Meanwhile, ink containing an alkanediol sparingly soluble in water and the two water-soluble alkanediols described above in combination as the alcohol solvent is more likely to dry than those containing an alkanediol sparingly soluble in water, a water-soluble alkanediol, and an alkanetriol. Thus, such ink probably enables printing of high-quality images not only on low-liquid-absorbency recording media, such as printing paper, but also on recording media having no liquid absorbency, such as resin films.

In the present invention, preferred examples of the alkanediol sparingly soluble in water include alkanediols having seven or more carbon atoms, for example, 1,2-heptanediol, 1,2-octanediol, 5-methyl-1,2-hexanediol, 4-methyl-1,2-hexanediol, and 4,4-dimethyl-1,2-pentanediol. A more preferred example is 1,2-octanediol.

Also, preferred examples of the water-soluble 1,2-alkanediol include alkanediols having six or less carbon atoms, for example, 1,2-hexanediol, 1,2-pentanediol, 1,2-butanediol, 4-methyl-1,2-pentanediol, and 3,3-dimethyl-1,2-butanediol. More preferred examples include water-soluble alkanediols a 15% aqueous solution of which has a surface tension of 28 mN/m or lower, and particularly preferred examples are 1,2-hexanediol (surface tension: 26.7 mN/m), 4-methyl 1,2-pentanediol (surface tension: 25.4 mN/m), and 3,3-dimethyl-1,2-butanediol (surface tension: 26.1 mN/m). Considering an odor emitted during printing, 1,2-hexanediol is preferable.

Also, preferred examples of the water-soluble 1,3-alkanediol include alkanediols having four or more carbon atoms along the main chain thereof, for example, 1,3-butanediol and 3-methyl-1,3-butanediol.

As for the three alcohol solvents described above, the ratio of the content of the alkanediol sparingly soluble in water to the content of the water-soluble 1,2-alkanediol is preferably in the range of 6:1 to 1:3 and more preferably in the range of 6:1 to 1:1. A ratio falling within this range would allow for consistent dissolution of the alkanediol sparingly soluble in water in ink, thereby improving the discharge stability of the ink. However, a content ratio of the water-soluble 1,2-alkanediol higher than the range indicated above would make it difficult to achieve reduction of the initial viscosity of the ink and prevention of aggregation spots simultaneously. On the other hand, a content ration of the water-soluble 1,2-alkanediol lower than the range indicated above would make it difficult to dissolve the alkanediol sparingly soluble in water in the ink in a consistent manner, thereby making it difficult to prevent changes in the viscosity of the ink over time and to maintain the storage stability of the ink.

Also, the content ratios of the alkanediol sparingly soluble in water to the water-soluble 1,3-alkanediol are preferably in the range of 1:1 to 1:18 and more preferably in the range of 1:1 to 1:6. The content ratios falling within this range would reduce the initial viscosity of the ink and provide the ink with favorable resilience from clogging. However, a content ratio of the water-soluble 1,3-alkanediol higher than the range indicated above would increase the initial viscosity of the ink, thereby reducing the drying rate of the ink. On the other hand, a content ratio of the water-soluble 1,3-alkanediol lower than the range indicated above would reduce the resilience of the ink to clogging and increase the drying rate of the ink. This means that the ink has a shorter time to spread while being wet and thus covers the recording medium incompletely, often leaving white stripes thereon.

Also, the ratio of the content of the water-soluble 1,2-alkanediol to the content of the water-soluble 1,3-alkanediol is preferably in the range of 1:1 to 1:36 and more preferably in the range of 1:1 to 1:18. This range would more effectively reduce white stripes and roughness when images are printed on printing paper at low resolution. However, a content ratio of the water-soluble 1,2-alkanediol higher than the range indicated above would increase the initial viscosity of the ink, thereby reducing the drying rate of the ink. On the other hand, a content ratio of the water-soluble 1,3-alkanediol lower than the range indicated above would reduce the resilience of the ink to clogging and increase the drying rate of the ink. This means that the ink has a shorter time to spread while being wet and thus covers the recording medium incompletely, often leaving white stripes thereon.

The content ratio of the alkanediol sparingly soluble in water relative to the entire ink composition is preferably in the range of 1 to 3 wt % and more preferably in the range of 1.5 to 2.5 wt %. A content ratio of the alkanediol sparingly soluble in water relative to the entire ink composition lower than 1 wt % would possibly cause printing spots when a low-ink-absorbency recording medium, such as printing paper, is used. On the other hand, a content ratio of the alkanediol sparingly soluble in water relative to the entire ink composition higher than 3 wt % would possibly result in incomplete dissolution of the alkanediol sparingly soluble in water in the ink.

The content ratio of the water-soluble 1,2-alkanediol is preferably in the range of 0.5 to 6 wt % and more preferably in the range of 0.5 to 3.0 wt %. A content ratio lower than 0.5 wt % would possibly result in incomplete dissolution of the alkanediol sparingly soluble in water in the ink. On the other hand, a content ratio higher than 6 wt % would possibly increase the initial viscosity of the ink and thus is unfavorable.

The content ratio of the water-soluble 1,3-alkanediol relative to the entire ink composition is preferably in the range of 3 to 18 wt % and more preferably in the range of 5 to 8 wt %. A content ratio lower than 3 wt % would possibly cause white stripes or roughness when prints are made on printing paper at low resolution. On the other hand, a content ratio higher than 18 wt % would possibly reduce the drying rate of fresh prints.

### <Coloring Material>

The coloring material used in the ink composition for ink jet recording according to the present invention may be dye or pigment; however, pigment is more suitable because of its resistance to light and water.

The pigment may be inorganic pigment or organic pigment and may consist of a single kind of pigment or a mixture of several kinds of pigments. Examples of the inorganic pigment mentioned above include titanium oxide, iron oxide, and carbon black produced using a known method such as the contact method, furnace method, and thermal method. On the other hand, examples of the organic pigment mentioned above include azo pigments (including azo lake, insoluble azo pigments, condensed azo pigments, and chelate azo pigments), polycyclic pigments (e.g., phthalocyanine pigments, perylene pigments, perinone pigments, anthraquinone pigments, quinacridone pigments, dioxazine pigments, thioindigo pigments isoindolinone pigments, and quinoflarone pigments), dye chelates (e.g., basic-dye-type chelates, acidic-dye-type chelates), nitro pigments, nitroso pigments, and aniline black.

The pigment used depends on the desired kind (color) of the ink composition. For instance, examples of pigment for a yellow ink composition include C.I. Pigment Yellow 1, 2, 3, 12, 14, 16, 17, 73, 74, 75, 83, 93, 95, 97, 98, 109, 110, 114, 128, 129, 138, 139, 147, 150, 151, 154, 155, 180, and 185, and one or more kinds of these pigments are used. In particular, one or more kinds selected from the group consisting of C.I. Pigment Yellow 74, 110, 128, and 147 are preferably used. Also, examples of pigment for a magenta ink composition include C.I. Pigment Red 5, 7, 12, 48 (Ca), 48 (Mn), 57 (Ca), 57:1, 112, 122, 123, 168, 184, 202, and 209 and C.I. Pigment Violet 19, and one or more kinds of these pigments are used. In particular, one or more kinds selected from the group consisting of C.I. Pigment Red 122, 202, and 209 and C.I. Pigment Violet 19 are preferably used. Furthermore, examples of pigment for a cyan ink composition include C.I. Pigment Blue 1, 2, 3, 15:3, 15:4, 15:34, 16, 22, and 60 and C.I. Vat Blue 4 and 60, and one or more kinds of these pigments are used. In particular, C.I. Pigment Blue 15:3 and/or 15:4 are preferably used, and C.I. Pigment Blue 15:3 is more preferably used.

Examples of pigment for a black ink composition include carbon black (C.I. Pigment Black 7) such as furnace black, lamp black, acetylene black, and channel black, inorganic pigments such as iron oxide pigments, and organic pigments such as aniline black (C.I. Pigment Black 1). In the present invention, carbon black is preferably used. Specific examples of carbon black include #2650, #2600, #2300, #2200, #1000, #980, #970, #966, #960, #950, #900, #850, MCF-88, #55, #52, #47, #45, #45L, #44, #33, #32, and #30 (these are manufactured by Mitsubishi Chemical Corporation), SpecialBlaek4A, 550, Printex95, 90, 85, 80, 75, 45, and 40 (these are manufactured by Degussa), Rega1660, RmogulL, monarch1400, 1300, 1100, 800, and 900 (these are manufactured by Cabot Corporation), and Raven7000, 5750, 5250, 3500, 3500, 2500ULTRA, 2000, 1500, 1255, 1200, 1190ULTRA, 1170, 1100ULTRA, and Raven5000UIII (these are manufactured by Columbian Chemicals Company).

The concentration of the pigment is not particularly limited because it can be adjusted to an appropriate concentration (content) during preparation of the ink composition; however, it is usually in the range of 5 to 20 wt %.

The pigment is preferably one kneaded with a dispersant, described later, because the use of such a pigment would simultaneously ensure the gloss of resulting images, prevention of bronzing, and the storage stability of the ink composition as well as provide resulting color images with better gloss.

### <Dispersant>

The ink composition according to the present invention preferably contains at least one resin selected from styrene-acrylic acid copolymer resins, urethane resins, and fluorene resins as a dispersant for dispersing the coloring material. These copolymer resins adsorb onto pigment, thereby promoting dispersion the pigment.

Specific examples of hydrophobic monomers constituting the copolymer resins include methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethylhexyl acrylate, 2-ethylhexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-diethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylolpropane triacrylate, trimethylolpropane trimethacrylate, glycerol acrylate, glycerol methacrylate, styrene, methyl styrene, and vinyl toluene. These may be used alone or in combination of two or more kinds thereof.

Specific examples of hydrophilic monomers include acrylic acid, methacrylic acid, maleic acid, and itaconic acid.

Copolymer resin consisting of the above-mentioned hydrophobic monomer and hydrophilic monomer is preferably at least one of a styrene-(meth)acrylic acid copolymer resin, a styrene-methyl styrene-(meth)acrylic acid copolymer resin, a styrene-maleic acid copolymer resin, a (meth)acrylic acid-(meth)acrylate copolymer resin, and a styrene-(meth)acrylic acid-(meth)acrylate copolymer resin because these copolymer resins simultaneously ensure the gloss of resulting color images, prevention of bronzing, and the storage stability of the ink composition as well as provide resulting color images with better gloss.

The copolymer resin may be resin containing polymer obtained by allowing styrene to react with acrylic acid or acrylate (styrene-acrylic acid resin). Salts thereof, such as sodium salt, potassium salt, and ammonium salt, may also be used.

Provided that the content of the pigment described earlier is 100 parts by weight, the content of these copolymer resins is preferably in the range of 10 to 50 parts by weight and more preferably in the range of 10 to 35 parts by weight because a content of these copolymer resins falling within this range would simultaneously ensure the gloss of resulting color images, prevention of bronzing, and the storage stability of the ink composition as well as provide resulting color images with better gloss.

Meanwhile, in the present invention, the use of urethane resin as the pigment dispersant would simultaneously ensure the gloss of resulting color images, prevention of bronzing, and the storage stability of the ink composition as well as provide resulting color images with better gloss. The urethane resin is a resin containing a polymer obtained by allowing a diisocyanate compound to react with a diol compound. In the present invention, it is preferably resin having a urethane bond and/or an amide bond and an acidic group.

Examples of the diisocyanate compound include aromatic aliphatic diisocyanate compounds such as hexamethylene diisocyanate and 2,2,4-trimethylhexamethylene diisocyanate, aromatic diisocyanate compounds such as toluoylene diisocyanate and phenylmethane diisocyanate, and denatured derivatives thereof.

Examples of the diol compound include polyethers such as polyethylene glycol and polypropylene glycol, polyesters such as polyethylene adibate and polybutylene adibate, and polycarbonates.

The urethane resin described above preferably contains a carboxyl group.

Fluorene resin may also be used as the pigment dispersant in the present invention.

The weight ratio of the above-described copolymer resin to the above-described urethane resin (the former/the latter) is preferably in the range of 1/2 to 2/1; however, it is more preferably in the range of 1/1.5 to 1.5/1 because this would simultaneously ensure the gloss of resulting color images, prevention of bronzing, and the storage stability of the ink composition as well as provide resulting color images with better gloss.

The weight ratio of the solid content of the above-described pigment to the solid content of the other components (the former/the latter) is preferably in the range of 100/20 to 100/80 because this would simultaneously ensure the gloss of resulting color images, prevention of bronzing, and the storage stability of the ink composition as well as provide resulting color images with better gloss.

Provided that the content of the pigment described earlier is 100 parts by weight, the content of the above-described copolymer resin is preferably in the range of 10 to 50 parts by weight and more preferably in the range of 10 to 35 parts by weight because a content of the above-described copolymer resin falling within this range would simultaneously ensure the gloss of resulting color images, prevention of bronzing, and the storage stability of the ink composition as well as provide resulting color images with better gloss.

Provided that the content of the pigment described earlier is 100 parts by weight, the content of the above-described urethane resin is preferably in the range of 10 to 40 parts by weight and more preferably in the range of 10 to 35 parts by weight because a content of the above-described urethane resin falling within this range would simultaneously ensure the gloss of resulting color images, prevention of bronzing, and the storage stability of the ink composition as well as provide resulting color images with better gloss.

Provided that the content of the pigment described earlier is 100 parts by weight, the content of the above-described fluorene resin is preferably in the range of 20 to 200 parts by weight and more preferably in the range of 10 to 80 parts by weight because a content of the above-described fluorene resin falling within this range would simultaneously ensure the gloss of resulting color images, prevention of bronzing, and the storage stability of the ink composition as well as provide resulting color images with better gloss.

Provided that the content of the pigment described earlier is 100 parts by weight, the total content of the above-described copolymer resin and the above-described urethane resin is preferably 90 parts by weight or lower (more preferably 70 parts by weight or lower) because a total content of the above-described copolymer resin falling within this range would simultaneously ensure the gloss of resulting color images, prevention of bronzing, and the storage stability of the ink composition as well as provide resulting color images with better gloss.

The acid value of the above-described copolymer resin is preferably in the range of 50 to 320 and more preferably in the range of 100 to 250 because an acid value of the above-described copolymer resin falling within this range would simultaneously ensure the gloss of resulting color images, prevention of bronzing, and the storage stability of the ink composition as well as provide resulting color images with better gloss.

The acid value of the above-described urethane resin is preferably in the range of 10 to 300 and more preferably in the range of 20 to 100 because an acid value of the above-described urethane resin falling within this range would simultaneously ensure the gloss of resulting color images, prevention of bronzing, and the storage stability of the ink composition as well as provide resulting color images with better gloss. It should be noted that the acid value corresponds to the quantity of KOH in mg needed to neutralize 1 g of the resin.

The weight-average molecular weight (Mw) of the above-described copolymer resin is preferably in the range of 2,000 to 30,000 and more preferably in the range of 2,000 to 20,000 because a weight-average molecular weight of the above-described copolymer resin falling within this range would simultaneously ensure the gloss of resulting color images, prevention of bronzing, and the storage stability of the ink composition as well as provide resulting color images with better gloss.

The weight-average molecular weight (Mw) of the above-described urethane resin is preferably in the range of 100 to 200,000 and more preferably in the range of 1000 to 50,000 because a weight-average molecular weight of the above-described urethane resin falling within this range would simultaneously ensure the gloss of resulting color images, prevention of bronzing, and the storage stability of the ink composition as well as provide resulting color images with better gloss. Mw can be measured by, for example, GPC (gel permeation chromatography).

The glass transition temperature (Tg; measured in accordance with JISK6900) of the above-described copolymer resin is preferably 30° C. or higher and more preferably in the range of 50 to 130° C. because a glass transition temperature falling within this range would simultaneously ensure the gloss of resulting color images, prevention of bronzing, and the storage stability of the ink composition as well as provide resulting color images with better gloss.

The glass transition temperature (Tg; measured in accordance with JISK6900) of the above-described urethane resin is preferably in the range of −50 to 200° C. and more preferably in the range of −50 to 100° C. because a glass transition temperature falling within this range would simultaneously ensure the gloss of resulting color images, prevention of bronzing, and the storage stability of the ink composition as well as provide resulting color images with better gloss.

The above-described copolymer resin existing in a pigment dispersant may adsorb onto or be separate from the pigment. This copolymer resin preferably has a maximum particle diameter of 0.3 μm or smaller and more preferably has an average particle diameter of 0.2 μm or smaller (much more preferably 0.1 μm or smaller) because a copolymer resin meeting these requirements would simultaneously ensure the gloss of resulting color images, prevention of bronzing, and the storage stability of the ink composition as well as provide resulting color images with better gloss. It should be noted that the average particle diameter is an average of disperse diameters of actual particles of pigment existing in a disperse liquid (diameters at 50% accumulation) and can be measured using, for example, Microtrac UPA (MicrotracInc.).

Also, no limitation is imposed on the fluorene resin described above as long as the fluorene resin has a fluorene backbone. The fluorene resin can be obtained by copolymerization of, for example, the following monomer units:

Cyclohexane, 5-isocyanate-1-(isocyanatemethyl)-1,3,3-trimethyl (CAS No. 4098-71-9)

Ethanol, 2,2′-[9H-fluoren-9-ylidenebis(4,1-phenyleneoxy)]bis(CAS No. 117344-32-8)

Propionic acid, 3-hydroxy-2-(hydroxymethyl)-2-methyl (CAS No. 4767-03-7)

Ethaneamine and N,N-diethyl-(CAS No. 121-44-8)

A surfactant may also be used as the dispersant. Examples of the surfactant include anionic surfactants, such as fatty acid salts, higher-alkyl dicarboxylate salts, higher-alcohol sulfate esters and salts, higher-alkyl sulfonate salts, condensation products of higher fatty acids and amino acids, sulfosuccinate esters and salts, naphthenate salts, liquid fatty oil sulfate esters and salts, and alkyl allyl sulfonate salts; cationic surfactants, such as fatty acid amine salts, quaternary ammonium salts, sulfonium salts, and phosphonium; and nonionic surfactants, such as polyoxyethylene alkyl ethers, polyoxyethylene alkyl esters, sorbitan alkyl esters, and polyoxyethylene sorbitan alkyl esters. Added to the ink composition, the surfactants listed above exert, of course, the function of a surfactant as well.

### <Surfactant>

The ink composition for ink jet recording according to the present invention contains a surfactant as an essential component. When recording media having a surface coated with resin for receiving ink are used, the use of a surfactant would enable images having excellent gloss to be printed even on gloss-conscious recording media, such as photographic paper. In particular, when recording media whose surface ink-receiving layer has a coating layer for receiving oil-based ink, such as printing paper, are used, the use of a surfactant would prevent blurs between colors (breed) and bleaching due to light reflection occurring as the adhesion amount of ink increases.

Organopolysiloxane surfactants can be suitably used in the present invention as the surfactant to ensure that recording images are formed with the better wettability to the surface of a recording medium and the higher permeability of ink. The above-described three alcohol solvents contained improve the solubility of the organopolysiloxane surfactants in the ink and prevent formation of undissolved residues, and thus the resulting ink composition has better discharge stability.

The surfactant described above may be commercially available ones, for example, OLFINE PD-501 (manufactured by Nissin Chemical Industry Co., Ltd.), OLFINE PD-502 (manufactured by Nissin Chemical Industry Co., Ltd.), and OLFINE PD-570 (manufactured by Nissin Chemical Industry Co., Ltd.).

Meanwhile, the surfactant more preferably contains one or more compounds represented by the following formula (I):

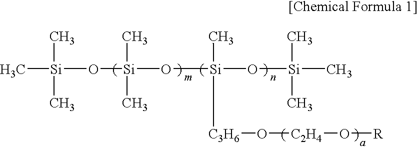

(where R represents a hydrogen atom or a methyl group, a an integer in the range of 2 to 11, m an integer in the range of 2 to 50, and n an integer in the range of 1 to 5) or one or more compounds represented by the formula (I) above with R being a hydrogen atom or a methyl group, a an integer in the range of 2 to 13, m an integer in the range of 2 to 50, and n an integer in the range of 1 to 5. More preferably, the surfactant contains one or more compounds represented by the formula (I) above with R being a hydrogen atom or a methyl group, a an integer in the range of 2 to 13, m an integer in the range of 2 to 50, and n an integer in the range of 1 to 8. More preferably, the surfactant contains one or more compounds represented by the formula (I) above with R being a methyl group, a being an integer in the range of 6 to 18, m being 0, and n being 1. The use of these particular organopolysiloxane surfactants would prevent aggregation unevenness of the ink even when prints are made on printing paper as a recording medium.

The compound represented by the formula (I) above is more preferably one having a being an integer in the range of 2 to 5, m an integer in the range of 20 to 40, and n an integer in the range of 2 to 4, one having a being an integer in the range of 7 to 11, m in the range of 30 to 50, and n in the range of 3 to 5, one having a being an integer in the range of 9 to 13, m an integer in the range of 2 to 4, and n an integer in the range of 1 to 2, or one having a being an integer in the range of 6 to 10, m an integer in the range of 10 to 20, and n an integer in the range of 4 to 8. The use of such a compound would more effectively prevent aggregation unevenness of the ink. An example is a mixed surfactant of a compound represented by the formula (I) above with R being a methyl group, a an integer in the range of 9 to 13, m an integer in the range of 2 to 4, and n an integer in the range of 1 to 2 and that having R being a hydrogen atom, a an integer in the range of 7 to 11, m an integer in the range of 30 to 50, and n an integer in the range of 3 to 5.

Also, the compound represented by the formula (I) above is much more preferably one having R being a hydrogen atom and a being an integer in the range of 2 to 5, m an integer in the range of 20 to 40, and n an integer in the range of 2 to 4 or a being an integer in the range of 7 to 11, m an integer in the range of 30 to 50, and n an integer in the range of 3 to 5. The use of such a compound would more effectively prevent aggregation unevenness and breed of the ink.

Also, the compound represented by the formula (I) above is much more preferably one having R being a methyl group and a being an integer in the range of 9 to 13, m an integer in the range of 2 to 4, and n an integer in the range of 1 to 2 or a being an integer in the range of 6 to 10, m an integer in the range of 10 to 20, and n an integer in the range of 4 to 8. The use of such a compound would more effectively prevent aggregation unevenness and breed of the ink.

Furthermore, the compound represented by the formula (I) above is much more preferably one having R being a methyl group, a being an integer in the range of 6 to 12, m being 0, and n being 1. The use of such a compound would more effectively prevent aggregation unevenness and breed of the ink.

The most preferably, the compound represented by the formula (I) above is a mixture of a compound having R being a hydrogen atom, a an integer in the range of 7 to 11, m an integer in the range of 30 to 50, and n an integer in the range of 3 to 5, a compound having R being a methyl group, a an integer in the range of 9 to 13, m an integer in the range of 2 to 4, and n an integer in the range of 1 to 2, and a compound having R being a methyl group, a an integer in the range of 6 to 10, m an integer in the range of 10 to 20, and n an integer in the range of 4 to 8. The use of such a compound would much more effectively prevent aggregation unevenness and breed of the ink.

Also, the most preferably, the compound represented by the formula (I) above is a mixture of a compound having R being a hydrogen atom, a an integer in the range of 7 to 11, m an integer in the range of 30 to 50, and n an integer in the range of 3 to 5, a compound having R being a methyl group, a an integer in the range of 9 to 13, m an integer in the range of 2 to 4, and n an integer in the range of 1 to 2, and a compound having R being a methyl group, a being an integer in the range of 6 to 18, m being 0, and n being 1. The use of such a compound would much more effectively prevent aggregation unevenness and breed of the ink.

The content ratio of the surfactant described above contained in the ink composition according to the present invention is preferably in the range of 0.01 to 1.0 wt % and more preferably in the range of 0.05 to 0.50 wt %. The concurrent use of the above-described surfactant having R being a methyl group and the above-described surfactant having R being a hydrogen atom is more preferable because this protects letters having small font sizes from being crushed. In particular, in using the above-described surfactant having R being a methyl group, the content ratio of the surfactant is preferably larger than that in using the above-described surfactant having R being H, considering the aggregation spots of the ink.

Additionally, the content ratio of the above-described surfactant having R being H is preferably higher than that of the above-described surfactant having R being a methyl group. This enables aggregation spots and breed of the ink to be more effectively prevented even in producing prints on printing paper that is likely to repel ink and into which ink penetrates slowly, such as cast-coated paper.

The ink composition according to the present invention may further contain an additional surfactant, more specifically, an acetylene glycol surfactant, an anionic surfactant, a nonionic surfactant, or an amphoteric surfactant.

Examples of the acetylene glycol surfactant include 2,4,7,9-tetramethyl-5-decyn-4,7-diol, 3,6-dimethyl-4-octyn-3,6-diol, 3,5-dimethyl-1-hexyn-3 ol, and 2,4-dimethyl-5-hexyn-3-ol. The acetylene glycol surfactant may be commercially available one, for example, OLFINE E1010, STG, Y (a trade name of Nissin Chemical Industry Co., Ltd.) and Surfynol 61, 104, 82, 465, 485, and TG (trade names of Air Products and Chemicals Inc.).

### <Water and Other Components>

The ink composition for ink jet recording according to the present invention contains water as a solvent as well as the particular alcohol solvents, surfactant, and other additives described above. The water is preferably purified water, such as ion-exchanged water, ultrafiltered water, reverse-osmosis water, and distilled water, or ultrapure water. In particular, water sterilized by irradiation with ultraviolet light, addition of hydrogen peroxide thereto, or the like is preferably because, in such water, emergence of mold and bacteria is prevented for a long period of time.

Also, the ink composition according to the present invention preferably contains a penetrant in addition to the components mentioned above.

Glycol ethers can be suitably used as the penetrant.

Specific examples of the glycol ethers include ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol-iso-propyl ether, dipropylene glycol mono-n-butyl ether, dipropylene glycol mono-tert-butyl ether, and 1-methyl-1-methoxy butanol, and these compounds can be used alone or as a mixture of two or more kinds thereof.

Among these glycol ethers, alkyl ethers of polyhydric alcohols are preferable, and, in particular, ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, and triethylene glycol mono-n-butyl ether are preferable. A more preferred example is triethylene glycol mono-n-butyl ether.

The content ratio of the penetrant mentioned above can be appropriately specified; however, it is preferably approximately in the range of 0.1 to 30 wt % and more preferably approximately in the range of 1 to 20 wt %.

Additionally, the ink composition according to the present invention preferably contains a solvent for recording media in addition to the components mentioned above.

Pyrrolidones, such as N-methyl-2-pyrrolidone, can be suitably used as the solvent for recording media. The content ratio of the solvent for recording media mentioned above can be appropriately specified; however, it is preferably approximately in the range of 0.1 to 30 wt % and more preferably approximately in the range of 1 to 20 wt %.

Also, the ink composition for ink jet recording according to the present invention preferably contains substantially no humectant. Humectants have the function of preventing ink from being dried and solidified in ink jet nozzles and so forth. Thus, when dropped onto synthetic paper constituted of films having low ink-absorbing performance, ink containing such a humectant would be unlikely to dry, thereby sometimes posing problems in high-speed printing. Furthermore, the use of ink containing such a humectant would allow ink to adhere to a recording medium with the previous ink remaining unabsorbed on the surface of the recording medium, thereby sometimes causing aggregation spots.

The present invention, therefore, preferably contains substantially no humectant when such recording media having low ink-absorbing performance are used. In addition, ink dried and solidified in an ink jet nozzle can be dissolved once again by a solution containing a humectant.

In particular, the present invention preferably contains substantially no humectant whose vapor pressure at 25° C. is 2 mPa or lower. The term “substantially no humectant” means that the content ratio of the humectant in the ink composition is less than 1 wt %.

The ink containing a humectant whose vapor pressure at 25° C. is 2 mPa or lower at a content ratio of less than 1 wt % would enable images to be printed on metal or plastic materials having no ink-absorbing performance using the ink jet recording technique. It should be noted that, although it is obvious to those skilled in the art that some of the penetrant solvents described above act also as humectants, the penetrant solvents mentioned in this specification are not included in humectants. The alcohol solvents mentioned in this specification are also not included in humectants.

Examples of the humectant include those for commonly used ink for ink jet recording, more specifically, glycerin, ethylene glycol, diethylene glycol, triethylene glycol, propylene glycol, trimethylol propane, trimethylol methane, and trimethylol ethane.

The ink composition according to the present invention may further contain an anti-nozzle-clogging agent, an antiseptic, an antioxidant, an electric-conductivity adjuster, a pH adjuster, a viscosity adjuster, a surface-tension adjuster, an oxygen absorber, and so forth.

Examples of the antiseptic and a fungicide include sodium benzoate, sodium pentachlorophenol, sodium 2-pyridinethiol-1-oxide, sodium sorbate, sodium dehydroacetate, and 1,2-dibenzinethiazolin-3-one (Proxel CRL, Proxel BND, Proxel GXL, Proxel XL-2, and Proxel TN manufactured by ICI Plc.).

Also, examples of the pH adjuster, a dissolution aid, and the antioxidant include amines, such as diethanol amines, triethanol amines, propanol amines, and morpholine, and denatured derivatives thereof; inorganic acid salts, such as potassium hydroxide, sodium hydroxide, and lithium hydroxide; ammonium hydroxide and quaternary ammonium hydroxide (e.g., tetramethyl ammonium); carbonates, such as potassium carbonate, sodium carbonate, and lithium carbonate; phosphates; N-methyl-2-pyrrolidone; urea compounds, such as urea, thiourea, and tetramethylurea; allophanate compounds, such as allophanate and methyl allophanate; biuret compounds, such as biuret, dimethyl biuret, and tetramethyl biuret; and L-ascorbic acid and salts thereof.

Also, the ink composition according to the present invention may contain an antioxidant and an ultraviolet absorber, for example, Ciba Speciality Chemicals' Tinuvin 328, 900, 1130, 384, 292, 123, 144, 622, 770, and 292, Irgacor 252 153, Irganox 1010, 1076, and 1035, and MD1024, and lanthanide oxides.

The ink composition according to the present invention can be manufactured by dispersing and mixing the components described above using an appropriate method. A preferred method for preparing the ink solution is as follows: Pigment, a polymer dispersant, and water are mixed using an appropriate dispersing apparatus (e.g., a ball mill, a sand mill, an attritor, a roll mill, an agitator mill, a Henschel mixer, a colloid mill, an ultrasonic homogenizer, a jet mill, and Angmill) to prepare uniform pigment disperse liquid; and then separately prepared resin (a resin emulsion), water, a water-soluble organic solvent, sugar, a pH adjuster, an antiseptic, a fungicide, and so forth are added thereto and then dissolved well. Following sufficient agitation, the ink solution is filtered to remove coarse particle diameters and impurities that may cause clogging, and thus the intended ink composition is obtained.

Ink Jet Recording Method

The ink jet recording method according to the present invention is one in which droplets of the ink composition described above are discharged so as to adhere to a recording medium to print letters. The recording method according to the present invention, in which synthetic paper or printing paper is preferably used as the recording medium, enables high-quality images having no white stripes or roughness to be printed on such paper, in particular, art paper, high-quality paper used for POD (print-on-demand), and exclusive paper for laser printers, even at low resolution. Examples of the high-quality paper for POD include Ricoh Business Coat Gloss 100 (manufactured by Ricoh Company, Ltd.). Also, examples of the exclusive paper for laser printers, such as LPCCTA4 (manufactured by Seiko Epson Corporation), include things.

### EXAMPLES

Hereinafter, the present invention is described in more detail with reference to examples but is not limited to these examples.

### <Preparation of the Ink Composition>

The components according to the compositions shown in Table 1 below were mixed and then filtered using a 10-μm membrane filter to prepare the individual inks. In this table, the styrene-acrylic acid resin is a copolymer having a molecular weight of 1600 and an acid value of 150; the urethane resin is a copolymer having a molecular weight of 6000 and an acid value of 50; and the fluorene resin is a resin having a molecular weight of 3300 and containing monomer having a fluorene backbone, CAS No. 117344-32-8, at a monomer constituent ratio of approximately 50 wt %. The surfactant used was an organopolysiloxane surfactant obtained by mixing two compounds represented by the formula (I) shown earlier, one having R being a methyl group, a an integer in the range of 9 to 13, m an integer in the range of 2 to 4, and n an integer in the range of 1 to 2 and the other having R being a hydrogen atom, a an integer in the range of 7 to 11, m an integer in the range of 30 to 50, and n an integer in the range of 3 to 5.

TABLE 1

| | | Example 1 | | | | Example 2 | | | | Example 3 | | | | Example 4 | | | |
|---|---|---|---|---|---|---|---|---|---|---|---|---|---|---|---|---|---|
| | | Ink Set 1 | | | | Ink Set 2 | | | | Ink Set 3 | | | | Ink Set 4 | | | |
| Composition | | 1Y | 1M | 1C | 1K | 2Y | 2M | 2C | 2K | 3Y | 3M | 3C | 3K | 4Y | 4M | 4C | 4K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 3 | 3 | 3 | 3 | 3 | 3 | 3 | 3 | 3 | 3 | 3 | 3 | 3 | 3 | 3 | 3 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 5 | | | | Example 6 | | | | Example 7 | | | | Example 8 | | | |
| | | Ink Set 5 | | | | Ink Set 6 | | | | Ink Set 7 | | | | Ink Set 8 | | | |
| Composition | | 5Y | 5M | 5C | 5K | 6Y | 6M | 6C | 6K | 7Y | 7M | 7C | 7K | 8Y | 8M | 8C | 8K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 8 | 8 | 8 | 8 | 8 | 8 | 8 | 8 | 8 | 8 | 8 | 8 | 8 | 8 | 8 | 8 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 9 | | | | Example 10 | | | | Example 11 | | | | Example 12 | | | |
| | | Ink Set 9 | | | | Ink Set 10 | | | | Ink Set 11 | | | | Ink Set 12 | | | |
| Composition | | 9Y | 9M | 9C | 9K | 10Y | 10M | 10C | 10K | 11Y | 11M | 11C | 11K | 12Y | 12M | 12C | 12K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 18 | 18 | 18 | 18 | 18 | 18 | 18 | 18 | 18 | 18 | 18 | 18 | 18 | 18 | 18 | 18 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 13 | | | | Example 14 | | | | Example 15 | | | | Example 16 | | | |
| | | Ink Set 13 | | | | Ink Set 14 | | | | Ink Set 15 | | | | Ink Set 16 | | | |
| Composition | | 13Y | 13M | 13C | 13K | 14Y | 14M | 14C | 14K | 15Y | 15M | 15C | 15K | 16Y | 16M | 16C | 16K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Fluorene resin | — | — | — | — | — | — | — | — | — | — | — | — | — | — | — | — |
| Alcohol solvent | 3-Methyl-1,3-butanediol | 3 | 3 | 3 | 3 | 3 | 3 | 3 | 3 | 3 | 3 | 3 | 3 | 3 | 3 | 3 | 3 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 17 | | | | Example 18 | | | | Example 19 | | | | Example 20 | | | |
| | | Ink Set 17 | | | | Ink Set 18 | | | | Ink Set 19 | | | | Ink Set 20 | | | |
| Composition | | 17Y | 17M | 17C | 17K | 18Y | 18M | 18C | 18K | 19Y | 19M | 19C | 19K | 20Y | 20M | 20C | 20K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Fluorene resin | — | — | — | — | — | — | — | — | — | — | — | — | — | — | — | — |
| Alcohol solvent | 3-Methyl-1,3-butanediol | 8 | 8 | 8 | 8 | 8 | 8 | 8 | 8 | 8 | 8 | 8 | 8 | 8 | 8 | 8 | 8 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 21 | | | | Example 22 | | | | Example 23 | | | | Example 24 | | | |
| | | Ink Set 21 | | | | Ink Set 22 | | | | Ink Set 23 | | | | Ink Set 24 | | | |
| Composition | | 21Y | 21M | 21C | 21K | 22Y | 22M | 22C | 22K | 23Y | 23M | 23C | 23K | 24Y | 24M | 24C | 24K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Fluorene resin | — | — | — | — | — | — | — | — | — | — | — | — | — | — | — | — |
| Alcohol solvent | 3-Methyl-1,3-butanediol | 18 | 18 | 18 | 18 | 18 | 18 | 18 | 18 | 18 | 18 | 18 | 18 | 18 | 18 | 18 | 18 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 25 | | | | Example 26 | | | | Example 27 | | | | Example 28 | | | |
| | | Ink Set 25 | | | | Ink Set 26 | | | | Ink Set 27 | | | | Ink Set 28 | | | |
| Composition | | 25Y | 25M | 25C | 25K | 26Y | 26M | 26C | 26K | 27Y | 27M | 27C | 27K | 28Y | 28M | 28C | 28K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | — | — | — | — | — | — | — | — | — | — | — | — | — | — | — | — |
| | Fluorene resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| Alcohol solvent | 3-Methyl-1,3-butanediol | 3 | 3 | 3 | 3 | 3 | 3 | 3 | 3 | 3 | 3 | 3 | 3 | 3 | 3 | 3 | 3 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 29 | | | | Example 30 | | | | Example 31 | | | | Example 32 | | | |
| | | Ink Set 29 | | | | Ink Set 30 | | | | Ink Set 31 | | | | Ink Set 32 | | | |
| Composition | | 29Y | 29M | 29C | 29K | 30Y | 30M | 30C | 30K | 31Y | 31M | 31C | 31K | 32Y | 32M | 32C | 32K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | — | — | — | — | — | — | — | — | — | — | — | — | — | — | — | — |
| | Fluorene resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| Alcohol solvent | 3-Methyl-1,3-butanediol | 8 | 8 | 8 | 8 | 8 | 8 | 8 | 8 | 8 | 8 | 8 | 8 | 8 | 8 | 8 | 8 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 33 | | | | Example 34 | | | | Example 35 | | | | Example 36 | | | |
| | | Ink Set 33 | | | | Ink Set 34 | | | | Ink Set 35 | | | | Ink Set 36 | | | |
| Composition | | 33Y | 33M | 33C | 33K | 34Y | 34M | 34C | 34K | 35Y | 35M | 35C | 35K | 36Y | 36M | 36C | 36K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | — | — | — | — | — | — | — | — | — | — | — | — | — | — | — | — |
| | Fluorene resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| Alcohol solvent | 3-Methyl-1,3-butanediol | 18 | 18 | 18 | 18 | 18 | 18 | 18 | 18 | 18 | 18 | 18 | 18 | 18 | 18 | 18 | 18 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 37 | | | | Example 38 | | | | Example 39 | | | | Example 40 | | | |
| | | Ink Set 37 | | | | Ink Set 38 | | | | Ink Set 39 | | | | Ink Set 40 | | | |
| Composition | | 37Y | 37M | 37C | 37K | 38Y | 38M | 38C | 38K | 39Y | 39M | 39C | 39K | 40Y | 40M | 40C | 40K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | — | — | — | — | — | — | — | — | — | — | — | — | — | — | — | — |
| | Urethane resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Fluorene resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| Alcohol solvent | 3-Methyl-1,3-butanediol | 3 | 3 | 3 | 3 | 3 | 3 | 3 | 3 | 3 | 3 | 3 | 3 | 3 | 3 | 3 | 3 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 41 | | | | Example 42 | | | | Example 43 | | | | Example 44 | | | |
| | | Ink Set 41 | | | | Ink Set 42 | | | | Ink Set 43 | | | | Ink Set 44 | | | |
| Composition | | 41Y | 41M | 41C | 41K | 42Y | 42M | 42C | 42K | 43Y | 43M | 43C | 43K | 44Y | 44M | 44C | 44K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | — | — | — | — | — | — | — | — | — | — | — | — | — | — | — | — |
| | Urethane resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Fluorene resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| Alcohol solvent | 3-Methyl-1,3-butanediol | 8 | 8 | 8 | 8 | 8 | 8 | 8 | 8 | 8 | 8 | 8 | 8 | 8 | 8 | 8 | 8 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 45 | | | | Example 46 | | | | Example 47 | | | | Example 48 | | | |
| | | Ink Set 45 | | | | Ink Set 46 | | | | Ink Set 47 | | | | Ink Set 48 | | | |
| Composition | | 45Y | 45M | 45C | 45K | 46Y | 46M | 46C | 46K | 47Y | 47M | 47C | 47K | 48Y | 48M | 48C | 48K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | — | — | — | — | — | — | — | — | — | — | — | — | — | — | — | — |
| | Urethane resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Fluorene resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| Alcohol solvent | 3-Methyl-1,3-butanediol | 18 | 18 | 18 | 18 | 18 | 18 | 18 | 18 | 18 | 18 | 18 | 18 | 18 | 18 | 18 | 18 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 49 | | | | Example 50 | | | | Example 51 | | | | Example 52 | | | |
| | | Ink Set 49 | | | | Ink Set 50 | | | | Ink Set 51 | | | | Ink Set 52 | | | |
| Composition | | 1Y | 1M | 1C | 1K | 2Y | 2M | 2C | 2K | 3Y | 3M | 3C | 3K | 4Y | 4M | 4C | 4K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 3 | 3 | 3 | 3 | 3 | 3 | 3 | 3 | 3 | 3 | 3 | 3 | 3 | 3 | 3 | 3 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 53 | | | | Example 54 | | | | Example 55 | | | | Example 56 | | | |
| | | Ink Set 53 | | | | Ink Set 54 | | | | Ink Set 55 | | | | Ink Set 56 | | | |
| Composition | | 5Y | 5M | 5C | 5K | 6Y | 6M | 6C | 6K | 7Y | 7M | 7C | 7K | 8Y | 8M | 8C | 8K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 8 | 8 | 8 | 8 | 8 | 8 | 8 | 8 | 8 | 8 | 8 | 8 | 8 | 8 | 8 | 8 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Example 57 | | | | Example 58 | | | | Example 59 | | | | Example 60 | | | |
| | | Ink Set 57 | | | | Ink Set 58 | | | | Ink Set 59 | | | | Ink Set 60 | | | |
| Composition | | 9Y | 9M | 9C | 9K | 10Y | 10M | 10C | 10K | 11Y | 11M | 11C | 11K | 12Y | 12M | 12C | 12K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 18 | 18 | 18 | 18 | 18 | 18 | 18 | 18 | 18 | 18 | 18 | 18 | 18 | 18 | 18 | 18 |
| | 1,2-Hexanediol | 0.5 | 0.5 | 0.5 | 0.5 | 0.5 | 0.5 | 0.5 | 0.5 | 3 | 3 | 3 | 3 | 3 | 3 | 3 | 3 |
| | 1,2-Octanediol | 1 | 1 | 1 | 1 | 3 | 3 | 3 | 3 | 1 | 1 | 1 | 1 | 3 | 3 | 3 | 3 |
| Surfactant | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | | Balance | Balance | Balance | Balance | Balance | Balance | Balance | Balance | Balance | Balance | Balance | Balance | Balance | Balance | Balance | Balance |
| Balance | | 100 | 100 | 100 | 100 | 100 | 100 | 100 | 100 | 100 | 100 | 100 | 100 | 100 | 100 | 100 | 100 |
| | | Comparative Example 1 | | | | Comparative Example 2 | | | | Comparative Example 3 | | | | Comparative Example 4 | | | |
| | | Ink Set 1 | | | | Ink Set 2 | | | | Ink Set 3 | | | | Ink Set 4 | | | |
| Composition | | 1Y | 1M | 1C | 1K | 2Y | 2M | 2C | 2K | 3Y | 3M | 3C | 3K | 4Y | 4M | 4C | 4K |
| Coloring material | C.I. Pigment Yellow 74 | 8.0 | — | — | — | 8.0 | — | — | — | 8.0 | — | — | — | 8.0 | — | — | — |
| | C.I. Pigment Red 122 | — | 8.0 | — | — | — | 8.0 | — | — | — | 8.0 | — | — | — | 8.0 | — | — |
| | C.I. Pigment Blue 15:4 | — | — | 8.0 | — | — | — | 8.0 | — | — | — | 8.0 | — | — | — | 8.0 | — |
| | C.I. Pigment Black 6 | — | — | — | 8.0 | — | — | — | 8.0 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | Urethane resin | — | — | — | — | — | — | — | — | — | — | — | — | — | — | — | — |
| | Fluorene resin | — | — | — | — | — | — | — | — | — | — | — | — | — | — | — | — |
| Alcohol solvent | 3-Methyl-1,3-butanediol | 0 | 0 | 0 | 0 | 0 | 0 | 0 | 0 | 3 | 3 | 3 | 3 | 18 | 18 | 18 | 18 |
| | 1,2-Hexanediol | 0.5 | 0.5 | 0.5 | 0.5 | 3 | 3 | 3 | 3 | 0 | 0 | 0 | 0 | 0 | 0 | 0 | 0 |
| | 1,2-Octanediol | 1 | 1 | 1 | 1 | 3 | 3 | 3 | 3 | 1 | 1 | 1 | 1 | 3 | 3 | 3 | 3 |

| | | | | | | | | | | | | | | | | |
|---|---|---|---|---|---|---|---|---|---|---|---|---|---|---|---|---|
| Surfactant | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Purified water | Balance | Balance | Balance | Balance | Balance | Balance | Balance | Balance | Balance | Balance | Balance | Balance | Balance | Balance | Balance | Balance |
| Balance | 100 | 100 | 100 | 100 | 100 | 100 | 100 | 100 | 100 | 100 | 100 | 100 | 100 | 100 | 100 | 100 |

| | |
|---|---|
| Comparative Example 5 | Comparative Example 6 |
| Ink Set 5 | Ink Set 6 |

| | | | | | | | | |
|---|---|---|---|---|---|---|---|---|
| Composition | 5Y | 5M | 5C | 5K | 6Y | 6M | 6C | 6K |

| | | | | | | | | | |
|---|---|---|---|---|---|---|---|---|---|
| Coloring material | C.I. Pigment Yellow 74 | 8.0 | — | — | — | 8.0 | — | — | — |
| | C.I. Pigment Red 122 | — | 8.0 | — | — | — | 8.0 | — | — |
| | C.I. Pigment Blue 15:4 | — | — | 8.0 | — | — | — | 8.0 | — |
| | C.I. Pigment Black 6 | — | — | — | 8.0 | — | — | — | 8.0 |
| Dispersant | Styrene-acrylic resin | 2.4 | 2.4 | 2.4 | 2.4 | 2.4 | 2.4 | 2.4 | 2.4 |
| | Urethane resin | — | — | — | — | — | — | — | — |
| | Fluorene resin | — | — | — | — | — | — | — | — |
| Alcohol solvent | 3-Methyl-1,3-butanediol | 3 | 3 | 3 | 3 | 18 | 18 | 18 | 18 |
| | 1,2-Hexanediol | 0.5 | 0.5 | 0.5 | 0.5 | 3 | 3 | 3 | 3 |
| | 1,2-Octanediol | 0 | 0 | 0 | 0 | 0 | 0 | 0 | 0 |

| | | | | | | | | |
|---|---|---|---|---|---|---|---|---|
| Surfactant | 0.1 | 0.1 | 0.1 | 0.1 | 0.1 | 0.1 | 0.1 | 0.1 |
| Purified water | Balance | Balance | Balance | Balance | Balance | Balance | Balance | Balance |
| Balance | 100 | 100 | 100 | 100 | 100 | 100 | 100 | 100 |

### Examples 49 to 60

Ink Sets 49 to 60 were prepared in the same way as Examples 1 to 12 except that 3-methyl-1,3-butanediol was changed to 1,3-butanediol.

### Examples 61 to 120 and Comparative Examples 7 to 12

Example Ink Sets 61 to 120 and Comparative-example Ink Sets 7 to 12 were prepared in the same way as Examples 1 to 60 and Comparative Examples 1 to 6, respectively, except that the surfactant was changed to one described below.

The surfactant used in Examples 61 to 120 and Comparative Examples 7 to 12 was one composed of a compound represented by the formula (I) descried earlier with R being a methyl group, a an integer in the range of 6 to 10, m an integer in the range of 10 to 20, and n an integer in the range of 4 to 8.

### Examples 121 to 180 and Comparative Examples 13 to 18

Example Ink Sets 121 to 180 and Comparative-example Ink Sets 13 to 18 were prepared in the same way as Examples 1 to 60 and Comparative Examples 1 to 6, respectively, except that the surfactant was changed to one described below.

The surfactant used in Examples 121 to 180 and Comparative Examples 13 to 18 was one obtained by mixing a compound represented by the formula (I) descried earlier with R being a hydrogen atom, a an integer in the range of 7 to 11, m an integer in the range of 30 to 50, and n an integer in the range of 3 to 5, that having R being a methyl group, a an integer in the range of 9 to 13, m an integer in the range of 2 to 4, and n an integer in the range of 1 to 2, and that having R being a methyl group, a an integer in the range of 6 to 10, m an integer in the range of 10 to 20, and n an integer in the range of 4 to 8.

### Examples 181 to 240 and Comparative Examples 19 to 24

Example Ink Sets 181 to 240 and Comparative-example Ink Sets 19 to 24 were prepared in the same way as Examples 1 to 60 and Comparative Examples 1 to 6, respectively, except that the surfactant was changed to one described below.

The surfactant used in Examples 181 to 240 and Comparative Examples 19 to 24 was one composed of a compound represented by the formula (I) descried earlier with R being a methyl group, a being an integer in the range of 6 to 18, m being 0, and n being 1.

### Examples 241 to 300 and Comparative Examples 25 to 30

Example Ink Sets 241 to 300 and Comparative-example Ink Sets 25 to 30 were prepared in the same way as Examples 1 to 60 and Comparative Examples 1 to 6, respectively, except that the surfactant was changed to one described below.

The surfactant used in Examples 241 to 300 and Comparative Examples 25 to 30 was one obtained by mixing a compound represented by the formula (I) descried earlier with R being a hydrogen atom, a an integer in the range of 7 to 11, m an integer in the range of 30 to 50, and n an integer in the range of 3 to 5, that having R being a methyl group, a an integer in the range of 9 to 13, m an integer in the range of 2 to 4, and n an integer in the range of 1 to 2, and that having R being a methyl group, a being an integer in the range of 6 to 18, m being 0, and n being 1.

### <Evaluation>

Evaluation of the Initial Viscosity of Ink

The inks obtained as above were evaluated for the ink viscosity. One hour after the preparation of the inks, the ink viscosity was measured using a vibration viscometer (Model No. MV100 manufactured by Yamaichi Electronics Co., Ltd.) and evaluated in accordance with the following criteria. The measurement temperature was set at 20° C.

S: Viscosity is 4 mPa·s or lower.

AA: Viscosity is higher than 4 mPa·s but not higher than 5 mPa·s.

A: Viscosity is higher than 5 mPa·s but not higher than 6 mPa·s.

B: Viscosity is higher than 6 mPa·s but not higher than 7 mPa·s.

C: Viscosity is higher than 7 mPa·s but not higher than 8 mPa·s.

D: Viscosity is higher than 8 mPa·s.

The evaluation results were as shown in Table 2 below.

Evaluation of the Viscosity Transition of Ink

The inks prepared as above were allowed to stand for three days under conditions at 70° C. and then subjected to the measurement of the ink viscosity described above. The viscosity was evaluated in accordance with the following criteria.

A: The difference from the initial viscosity is 0.5 mPa·s or smaller.

B: The difference from the initial viscosity is larger than 0.5 mPa·s but not larger than 1.0 mPa·s.

C: The difference from the initial viscosity is larger than 1.0 mPa·s but not larger than 2.0 mPa·s.

D: The difference from the initial viscosity is larger than 2.0 mPa·s.

The evaluation results were as shown in Table 2 below.

Evaluation of Ink Aggregation Spots and Burials Excluding Cast-Coated Paper

The ink sets consisting of the Y, M, C, and K ink obtained as above were mounted on the ink cartridge of an ink jet printer (PX-G920 manufactured by Seiko Epson Corporation) so as to be ready for recording with 720 dpi in the primary scanning (head stroke) direction and 360 dpi in the secondary scanning (recording-medium transport) direction. Then, the voltage of the printer was adjusted so that the dot size at the time of adhesion was approximately 7 ng, and a solid fill image of 720×720 dpi was recorded on OKT+ (manufactured by Oji Paper Co., Ltd.) and LPCCT (Seiko Epson Corporation) each weighing approximately 128 g/m² with one stroke printing 720×360 dpi. Both one-way and two-way recording were performed under conditions at room temperature and room humidity. The adhesion amount of the ink was approximately 3.6 mg/inch m².

The obtained images were evaluated in accordance with the following criteria.

A: Even two-way printing results in aggregation spots and white stripes due to burial defects.

B: Two-way printing forms no aggregation spots but results in white stripes due to burial defects.

C: Two-way printing results in aggregation spots; one-way printing forms no aggregation spots but results in white stripes due to burial defects.

D: One-way printing results in aggregation spots and white stripes due to burial defects.

The results were as shown in Table 2 below.

Evaluation of Ink Aggregation Spots and Burials Using Cast-Coated Paper

The ink sets consisting of the Y, M, C, and K ink obtained as above were mounted on the ink cartridge of an ink jet printer (PX-G920 manufactured by Seiko Epson Corporation) so as to be ready for recording with 720 dpi in the primary scanning (head stroke) direction and 360 dpi in the secondary scanning (recording-medium transport) direction. Then, the voltage of the printer was adjusted so that the dot size at the time of adhesion was approximately 7 ng, and a solid fill image of 720×720 dpi was recorded on Mirrorkote Platinum (manufactured by Oji Paper Co., Ltd.) weighing approximately 128 g/m² with one stroke printing 720×360 dpi.

Both one-way and two-way recording were performed under conditions at room temperature and room humidity. The adhesion amount of the ink was approximately 3.6 mg/inch m².

The obtained images were evaluated in accordance with the following criteria.

A: Even two-way printing results in aggregation spots and white stripes due to burial defects.

B: Two-way printing forms no aggregation spots but results in white stripes due to burial defects.

C: Two-way printing results in aggregation spots; one-way printing forms no aggregation spots but results in white stripes due to burial defects.

D: One-way printing results in aggregation spots and white stripes due to burial defects.

The results were as shown in Table 2 below.

Evaluation of Crushed Small Letters

The ink sets consisting of the Y, M, C, and K ink obtained as above were mounted on the ink cartridge of an ink jet printer (PX-G920 manufactured by Seiko Epson Corporation) so as to be ready for recording with 720 dpi in the primary scanning (head stroke) direction and 360 dpi in the secondary scanning (recording-medium transport) direction. Then, the voltage of the printer was adjusted at room temperature and room humidity so that the dot size at the time of adhesion was approximately 7 ng. One stroke was 720×360 dpi, and the adhesion fee of the ink was approximately 3.6 mg/inch m² when a solid fill image of 720×720 dpi was recorded. Under these conditions, one-way printing of two Chinese characters that collectively stand for roses, consisting of many and complex strokes, with font sizes of 8 and 12 was performed on OKT+ (manufactured by Oji Paper Co., Ltd.) weighing approximately 128 g/m².

The obtained letters were evaluated in accordance with the following criteria.

A: The Chinese characters having a font size of 8 are easy to read.

B: The Chinese characters having a font size of 12 are easy to read, but those having a font size of 8 are difficult to read.

C: The Chinese characters having a font size of 12 are difficult to read.

The results were as shown in Table 2 below.

Evaluation of Ease in Drying

Also, printing in the recording method above was performed using polyethylene terephthalate films (Lumirror manufactured by Toray Industries, Inc.) as the recording media instead of OKT+ and LPCCT. The obtained prints were allowed to dry for three minutes under conditions at 40° C. and 15% RH, and then XeroxP (manufactured by Xerox Corporation) was placed on the print side and a pressure of 500 g/cm² was applied thereonto for three minutes. Subsequently, the sheets of XeroxP were subjected to OD-value measurement on the surface thereof having ink transferred from the prints, where SPM50 manufactured by Gretag was used. The drying rate was evaluated using the measured OD values.

The evaluation criteria were as follows.

A: The OD value is lower than 0.2.

B: The OD value is 0.2 or higher.

The results were as shown in Table 2 below.

Evaluation of Resilience from Clogging

The button for ink changes of the ink jet printer described above, which had the ink cartridge described above, was pressed, and then the receptacle was removed. With the head cap thereof being removed, the printer was allowed to stand for two days under conditions at 40° C. and 15% RH.

After the printer stood for the period described above, the cleaning operation thereof was repeated until the discharge performance of all the nozzles recovered to the initial level. Then, the resilience from clogging was evaluated in accordance with the following criteria.

A: Clogging dissolves after the cleaning operation is repeated three times.

B: Clogging dissolves after the cleaning operation is repeated six times.

C: Clogging dissolves after the cleaning operation is repeated twelve times.

D: Clogging does not dissolve even after the cleaning operation is repeated twelve times.

The results were as shown in Table 2 below.

TABLE 2

| | | | Ink aggregation spots | | | | |
|---|---|---|---|---|---|---|---|
| | Ink viscosity | | and burials | | | | |
| | | Viscosity | Other than | | Crushed small | | |
| | Initial viscosity | transition | cast paper | Cast paper | letters | Drying rate | Clogging |
| Example 1 | A | C | C | D | B | A | C |
| Example 2 | C | D | B | C | B | A | C |
| Example 3 | B | D | C | B | B | A | C |
| Example 4 | C | D | B | C | B | A | C |
| Example 5 | A | C | C | D | B | B | C |
| Example 6 | C | D | B | C | B | B | C |
| Example 7 | C | D | C | D | B | B | C |
| Example 8 | C | D | A | B | B | B | C |
| Example 9 | C | C | C | D | B | B | B |
| Example 10 | C | D | A | B | B | B | B |
| Example 11 | C | D | B | C | B | B | B |
| Example 12 | C | D | A | B | B | B | B |
| Example 13 | S | B | C | D | B | A | C |
| Example 14 | AA | B | B | C | B | A | C |
| Example 15 | S | B | C | D | B | A | C |
| Example 16 | A | B | B | C | B | A | C |
| Example 17 | S | B | C | D | B | B | B |
| Example 18 | A | B | B | C | B | B | B |
| Example 19 | M | B | C | D | B | B | B |
| Example 2O | B | B | A | B | B | B | B |
| Example 21 | AA | B | C | D | B | B | A |
| Example 22 | B | B | A | B | B | B | A |
| Example 23 | A | B | B | C | B | B | A |
| Example 24 | C | B | A | B | B | B | A |
| | | | Ink aggregation spots | | | | |
| | Ink viscosity | | and burials | | | | |
| | | Viscosity | Other than | | Crushed small | | |
| | Initial viscosity | transition | cast paper | Cast paper | letters | Drying rate | Clogging |
| Example 25 | S | A | C | D | B | A | C |
| Example 26 | M | A | B | C | B | A | C |
| Example 27 | S | A | C | D | B | A | C |
| Example 28 | A | A | B | C | B | A | C |
| Example 29 | S | A | C | D | B | B | A |
| Example 30 | A | A | B | C | B | B | A |
| Example 31 | AA | A | C | D | B | B | A |
| Example 32 | B | A | A | B | B | B | A |
| Example 33 | AA | A | C | D | B | B | A |
| Example 34 | B | A | A | B | B | B | A |
| Example 35 | A | A | B | C | B | B | A |
| Example 36 | C | A | A | B | B | B | A |
| Example 37 | S | A | C | D | B | A | B |
| Example 38 | AA | A | B | C | B | A | B |
| Example 39 | S | A | C | D | B | A | B |
| Example 40 | A | A | B | C | B | A | B |
| Example 41 | S | A | C | D | B | B | A |
| Example 42 | A | A | B | C | B | B | A |
| Example 43 | AA | A | C | D | B | B | A |
| Example 44 | B | A | A | B | B | B | A |
| Example 45 | AA | A | C | D | B | B | A |
| Example 46 | B | A | A | B | B | B | A |
| Example 47 | A | A | B | C | B | B | A |
| Example 48 | C | A | A | B | B | B | A |
| | | | Ink aggregation spots | | | | |
| | Ink viscosity | | and burials | | | | |
| | | Viscosity | Other than | | Crushed small | | |
| | Initial viscosity | transition | cast paper | Cast paper | letters | Drying rate | Clogging |
| Example 49 | A | C | C | D | B | A | C |
| Example 50 | C | D | B | C | B | A | C |
| Example 51 | B | D | C | B | B | A | C |
| Example 52 | C | D | B | C | B | A | C |
| Example 53 | A | C | C | D | B | B | C |
| Example 54 | C | D | B | C | B | B | C |
| Example 55 | C | D | C | D | B | B | C |
| Example 56 | C | D | A | B | B | B | C |
| Example 57 | C | C | C | D | B | B | B |
| Example 58 | C | D | A | B | B | B | B |
| Example 59 | C | D | B | C | B | B | B |
| Example 60 | C | D | A | B | B | B | B |
| Comparative | B | C | D | D | C | A | D |
| Examples 1 | | | | | | | |
| Comparative | D | D | D | D | C | A | D |
| Examples 2 | | | | | | | |
| Comparative | B | D | D | D | C | A | C |
| Examples 3 | | | | | | | |
| Comparative | D | D | D | D | C | B | B |
| Examples 4 | | | | | | | |
| Comparative | B | C | D | D | C | A | C |
| Examples 5 | | | | | | | |
| Comparative | D | C | D | D | C | B | B |
| Examples 6 | | | | | | | |

Examples 61 to 120 and Comparative Examples 7 to 12 were also evaluated as above. These examples and comparative examples were one-step better in terms of the ink aggregation spots and burials on cast-coated paper but two-step worse in terms of the crushed small letters. The evaluation results were comparable to those of Additional Examples 1 to 60 and Comparative Examples 1 to 6.

Then, Examples 121 to 180 and Comparative Examples 13 to 18 were also evaluated as above. These examples and comparative examples were one-step better in terms of the ink aggregation spots and burials on cast-coated paper but one-step worse in terms of the crushed small letters. The evaluation results were comparable to those of Examples 1 to 72 and Comparative Examples 1 to 6.

Then, Examples 181 to 240 and Comparative Examples 19 to 24 were also evaluated as above. These examples and comparative examples were one-step better in terms of the ink aggregation spots and burials on cast-coated paper but one-step worse in terms of the crushed small letters. The evaluation results were comparable to those of Examples 1 to 72 and Comparative Examples 1 to 6.

Then, Examples 241 to 300 and Comparative Examples 25 to 30 were also evaluated as above. These examples and comparative examples were one-step better in terms of the ink aggregation spots and burials on cast-coated paper but one-step worse in terms of the crushed small letters. The evaluation results were comparable to those of Examples 1 to 60 and Comparative Examples 1 to 6.

1. An ink composition for ink jet recording comprising a coloring material, water, an alcohol solvent, and a surfactant, wherein
the alcohol solvent contains an alkanediol sparingly soluble in water, a water-soluble 1,2-alkanediol, and a water-soluble 1,3-alkanediol.

2. The ink composition for ink jet recording according to claim 1, wherein the alkanediol sparingly soluble in water is an alkanediol having seven or more carbon atoms.

3. The ink composition for ink jet recording according to claim 1, wherein the water-soluble 1,2-alkanediol is an alkanediol having six or less carbon atoms.

4. The ink composition for ink jet recording according to any claim 1, wherein the water-soluble 1,3-alkanediol is an alkanediol having four or more carbon atoms.

5. The ink composition for ink jet recording according to claim 1, wherein a ratio of a content of the alkanediol sparingly soluble in water to a content of the water-soluble 1,2-alkanediol is in the range of 6:1 to 1:3.

6. The ink composition for ink jet recording according to claim 1, wherein a ratio of a content of the alkanediol sparingly soluble in water to a content of the water-soluble 1,3-alkanediol is in the range of 1:1 to 1:18.

7. The ink composition for ink jet recording according to claim 1, wherein a sum of a content of the alkanediol sparingly soluble in water and a content of the water-soluble 1,2-alkanediol is 6 wt % or less with respect to the ink composition.

8. The ink composition for ink jet recording according to claim 1, wherein a sum of a content of the alkanediol sparingly soluble in water and a content of the water-soluble 1,3-alkanediol is 21 wt % or less with respect to the ink composition.

9. The ink composition for ink jet recording according to claim 1, wherein the alkanediol sparingly soluble in water is contained at 1 to 3 wt % with respect to the ink composition.

10. The ink composition for ink jet recording according to claim 1, wherein the water-soluble 1,2-alkanediol is contained at 0.5 to 3.0 wt % with respect to the ink composition.

11. The ink composition for ink jet recording according to claim 1, wherein the water-soluble 1,3-alkanediol is contained at 3 to 18 wt % with respect to the ink composition.

12. The ink composition for ink jet recording according to claim 1, wherein the alkanediol sparingly soluble in water is 1,2-octanediol.

13. The ink composition for ink jet recording according to claim 1, wherein the water-soluble 1,2-alkanediol is one or more kinds selected from the group consisting of 1,2-hexanediol, 4-methyl 1,2-pentanediol, and 3,3-dimethyl-1,2-butanediol.

14. The ink composition for ink jet recording according to claim 1, wherein the water-soluble 1,3-alkanediol is 1,3-butanediol and/or 3-methyl-1,3-butanediol.

15. The ink composition for ink jet recording according to claim 1 wherein the surfactant is contained at 0.01 to 1.0 wt % with respect to the ink composition.

16. The ink composition for ink jet recording according to claim 15, wherein the surfactant is a polyorganosiloxane surfactant.

17. The ink composition for ink jet recording according to claim 16, wherein the polyorganosiloxane contains one or more compounds represented by the following formula: 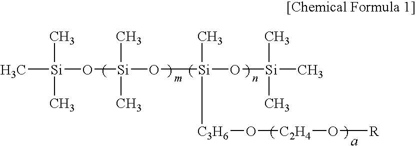
(where R represents a hydrogen atom or a methyl group, a represents an integer in the range of 2 to 11, m represents an integer in the range of 2 to 50, and n represents an integer in the range of 1 to 5).

18. The ink composition for ink jet recording according to claim 16, wherein the polyorganosiloxane contains one or more compounds represented by the following formula: 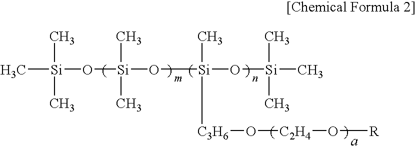
(where R represents a hydrogen atom or a methyl group, a represents an integer in the range of 2 to 13, m represents an integer in the range of 2 to 50, and n represents an integer in the range of 1 to 5).

19. The ink composition for ink jet recording according to claim 16, wherein the polyorganosiloxane contains one or more compounds represented by the following formula: 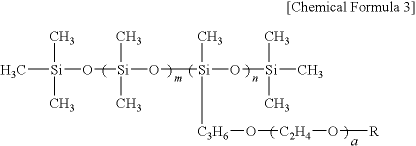
(where R represents a hydrogen atom or a methyl group, a represents an integer in the range of 2 to 13, m represents an integer in the range of 2 to 50, and n represents an integer in the range of 1 to 8).

20. The ink composition for ink jet recording according to claim 16, wherein the polyorganosiloxane contains one or more compounds represented by the following formula: 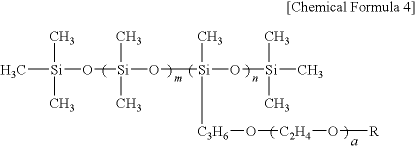
(where R represents a methyl group, a represents an integer in the range of 6 to 18, m is 0, and n is 1).

21. The ink composition for ink jet recording according to claim 1, wherein the coloring material contains a pigment and a dispersant enabling dispersion of the pigment in ink.

22. The ink composition for ink jet recording according to claim 21, wherein the dispersant contains at least one resin selected from a styrene-acrylic acid copolymer resin, a urethane resin, and a fluorene resin.

23. The ink composition for ink jet recording according to claim 22, wherein the dispersant is contained at 1.0 to 6.0 wt % with respect to the ink composition.

24. An ink jet recording method comprising a step of discharging a droplet of an ink composition and a step of allowing the droplet to adhere to a recording medium, thereby printing a letter, wherein the ink composition for ink jet recording according to claim 1 is used.

25. The method according to claim 24, wherein the recording medium is selected from the group consisting of synthetic paper mainly composed of a synthetic resin, printing paper, and a resin film.

26. The method according to claim 25, wherein the recording medium is a resin film.

27. A print recorded using the ink jet recording method according to claim 24.
